(19) United States
(12) Patent Application Publication
(10) Pub. No.: US 2021/0153501 A1
(43) Pub. Date: May 27, 2021

(54) PESTICIDE COMPOSITIONS AND METHODS OF USE THEREOF

(71) Applicant: IMERYS USA, INC., Roswell, GA (US)

(72) Inventors: David GITTINS, San Jose, CA (US); David STEWART, Alpharetta, GA (US)

(21) Appl. No.: 16/629,731

(22) PCT Filed: Jul. 11, 2018
(86) PCT No.: PCT/US2018/041572

§ 371 Date: Jan. 9, 2020

Related U.S. Application Data
(60) Provisional application No. 62/532,017, filed on Jul. 13, 2017.

(51) Int. Cl. A01N 25/08

(52) U.S. Cl. CPC A01N 25/08; A01N 2300/00

(57) ABSTRACT

The present disclosure includes compositions and methods for controlling a pest population, such as insects, arachnids, and other arthropods. The compositions herein may include mineral particles and at least one organic pesticide associated with the mineral particles, e.g., adsorbed and/or incorporated into portions of the mineral particles. For example, the composition may be applied to a substrate and/or an area having pests, such that the composition attaches to a pest proximate the substrate or in the area to deliver the organic pesticide(s) to the pest.

### CLAIM FOR PRIORITY

This PCT International Application claims the benefit of priority of U.S. Provisional Application No. 62/532,017, filed Jul. 13, 2017, the subject matter of which is incorporated herein by reference in its entirety.

### TECHNICAL FIELD

Embodiments of the present disclosure relate generally to compositions comprising biopesticides, including carrier materials useful for delivery of biopesticides to insects and other arthropods.

### BACKGROUND

Pest control is an important consideration in agriculture and horticulture, as well as in the home and commercial environments. For example, insects and arachnids can damage agricultural commodities, such as plants, crops, seeds, grain, and products derived from plants. Further, some insects such as mosquitos are known to transmit harmful and sometimes fatal diseases, such as malaria. Various compounds have been developed for pest control, however, delivery of such substances can be problematic.

### SUMMARY OF THE DISCLOSURE

The present disclosure includes methods for controlling a pest population, including, e.g., insects and/or arachnids. For example, the method may comprise applying a composition to an area, the composition comprising mineral particles and at least one organic pesticide, such as a biopesticide, associated with the mineral particles; wherein the composition attaches to a pest in the area to deliver the at least one biopesticide to the pest. According to some aspects of the present disclosure, the mineral particles may have a size distribution with a d₅₀ diameter of 15 μm or less, e.g., a d₅₀ diameter ranging from about 2 μm to about 12 μm, from about 5 μm to about 10 μm, or from about 2 μm to about 5 μm. Additionally or alternatively, the mineral particles may have a d₁₀ diameter of 2.5 μm or less and/or a d₉₀ diameter of 45 μm or less.

The mineral particles may comprise a silicate material and/or an aluminosilicate material, such as, e.g., diatomaceous earth, perlite (e.g., expanded perlite, or milled expanded perlite), or a mixture thereof. Further, for example, the composition may comprise at least one biopesticide chosen from a peptide, an oligonucleotide, a polynucleotide, a lipid, a carbohydrate, a microorganism, or a combination thereof. In at least one example, the composition comprises a peptide or an interference RNA molecule. The biopesticide(s) may be adsorbed to surfaces of the mineral particles and/or at least partially incorporated into crevices of the mineral particles.

According to some aspects of the present disclosure, the composition has an electrostatic charge sufficient to serve as a driving force for transferring the composition to the pest. In some examples, the electrostatic charge is positive. The composition may, for example, be applied to a substrate chosen from an agricultural commodity, a horticultural commodity, a building surface, a tape, or a netting. The frequency of application may vary depending on the composition, the environment, and/or the type of pest(s). In at least one example, the composition is applied to the area at least twice within 30 days. Controlling the pest population may include, for example, reducing the pest population by at least 20%, at least 30%, at least 40%, or at least 50% within 30 days of application of the composition.

Further, for example, the method for controlling a pest population may comprise applying a composition to a substrate, wherein the composition comprises mineral particles and at least one organic pesticide associated with the mineral particles; wherein the mineral particles have a size distribution with a d₅₀ diameter of 15 μm or less; and wherein the composition has an electrostatic charge (positive or negative) sufficient to transfer the composition from the substrate to a pest proximate the substrate to deliver the at least one organic pesticide to the pest. The pest may be, for example, an insect or an arachnid. In some examples, the outer surface of the pest may include lipid compounds. In some examples, the electrostatic charge of the composition is positive. The organic pesticide(s) may comprise a biopesticide and/or a small molecule insecticide. For example, the organic pesticide(s) may comprise one or more biopesticides chosen from peptides, oligonucleotides, polynucleotides, a lipid, a carbohydrate, microorganisms, or a combination thereof. The mineral particles may comprise perlite (e.g., expanded perlite, milled expanded perlite, etc.), diatomaceous earth, or a mixture thereof. In an exemplary size distribution of the mineral particles, the d₅₀ diameter ranges from about 2 μm to about 12 μm, from about 5 μm to about 10 μm, or from about 2 μm to about 5 μm.

Also included herein are compositions comprising mineral particles comprising at least one organic pesticide, such as a biopesticide. In some examples, the composition comprises mineral particles comprising a silicate, an aluminosilicate, or a combination thereof, the mineral particles having a d₅₀ diameter of 15 μm or less; and at least one biopesticide adsorbed to surfaces of the mineral particles or at least partially incorporated into crevices of the mineral particles. In some compositions herein, the mineral particles have a d₅₀ diameter ranging from about 2 μm to about 12 μm, from about 5 μm to about 10 μm, or from about 2 μm to about 5 μm. Additionally or alternatively, the mineral particles may have a d₁₀ diameter of 2.5 μm or less and/or a d₉₀ diameter of 45 μm or less.

According to some aspects of the present disclosure, the composition has an electrostatic charge sufficient to serve as a driving force for transferring the composition to a pest, such as an arthropod, e.g., an insect or arachnid. The electrostatic charge may be positive or negative. In some examples, the composition is in the form of a dry powder or a slurry, e.g., suitable for application to a substrate such as an agricultural commodity, a horticultural commodity, a building surface, tape, netting, as well as other substrates.

### DETAILED DESCRIPTION

Particular aspects of the present disclosure are described in greater detail below. The terms and definitions provided herein control, if in conflict with terms and/or definitions incorporated by reference.

As used herein, the terms “comprises,” “comprising,” or any other variation thereof are intended to cover a non-exclusive inclusion, such that a process, method, composition, article, or apparatus that comprises a list of elements does not include only those elements, but may include other elements not expressly listed or inherent to such process, method, composition, article, or apparatus. The term “exemplary” is used in the sense of “example” rather than “ideal.”

As used herein, the singular forms “a,” “an,” and “the” include plural reference unless the context dictates otherwise. The terms “approximately” and “about” refer to being nearly the same as a referenced number or value. As used herein, the terms “approximately” and “about” should be understood to encompass ±5% of a specified amount or value.

The present disclosure includes compositions and methods for eliminating or otherwise reducing the presence of pests. The composition may comprise mineral particles and one or more organic pesticides, such as a biopesticide and/or other organic pesticide such as a small molecule organic pesticide. For example, the particles may serve as a carrier for the organic pesticide(s) and/or as a mechanical pesticide, such that exposure to the composition results in the death of the pest. A pest as described herein may be any organism that negatively affects (e.g., damages or kills) a host (e.g., humans, plants, and/or animals), including, for example, organisms that remove blood, tissue, and/or any other fluid from their prey or host. Examples of pests that may be targeted with the compositions and methods herein include, but are not limited to, arthropods, e.g., insects (class Insecta), arachnids (class Arachnida), and/or myriapods (class Myriapoda). Insects include, for example, organisms of the orders Coleoptera, Diptera, Lepidopterea, Hemiptera, and Thysanoptera. For example, the pest may be a beetle, a potato beetle, a flea beetle, a larvae of a fly, a larvae of whitefly, a larvae of mosquito, a mosquito (e.g., Anopheles gambiae), a caterpillar of moths, a caterpillar of earworm, a corn earworm, a caterpillar of armyworm, a caterpillar of looper, a caterpillar of leafminer, a lygus bug, an aphid, a psyllid, a scale insect, a mealybug, a head louse, or a thrip. Arachnids include, for example, species of the subclass Acari, such as spider mites, rust mites, and gall mites. In some cases, the pest may be a myriapod, such as centipede, millipede, symphyla, pauropoda, or arthropleuridea. In some aspects of the present disclosure, the outer surface of the pest (e.g., arthropod cuticle or exoskeleton) may include lipid compounds, such as a wax layer.

According to some aspects of the present disclosure, the mineral particles may comprise silicate and/or aluminosilicate, including glassy minerals and materials derived from glassy minerals. Exemplary silicates and aluminosilicates include, but are not limited to, diatomaceous earth, perlite, pumice, volcanic ash, calcined kaolin, smectite, mica, shirasu, obsidian, pitchstone, rice hull ash, and combinations thereof.

Diatomaceous earth (also called “DE” or “diatomite”) is generally known as a sediment enriched in biogenic silica (silica produced or brought about by living organisms) in the form of siliceous frustules of diatoms. Diatoms are a diverse array of microscopic, single-celled, golden-brown algae generally of the class Bacillariophyceae that possess an ornate siliceous skeleton of varied and intricate structures including two valves that, in the living diatom, fit together much like a pill box.

Diatomaceous earth may form from the remains of water-borne diatoms, and therefore, diatomaceous earth deposits may be found close to either current or former bodies of water. Those deposits are generally divided into two categories based on source: freshwater and saltwater. Freshwater diatomaceous earth is generally mined from dry lakebeds and may be characterized as having a low crystalline silica content and a high iron content. In contrast, saltwater diatomaceous earth is generally extracted from oceanic areas and may be characterized as having a high crystalline silica content and a low iron content.

Glassy minerals, which may also be referred to as “volcanic glasses,” are formed by the rapid cooling of siliceous magma or lava. Volcanic glasses, such as perlite and pumice, tend to occur in large deposits. Volcanic ash, often referred to as “tuff” when in consolidated form, includes small particles or fragments that may be in glassy form and also characterized as a glassy mineral.

Perlite is a hydrated glassy mineral that comprises silicon dioxide, aluminum oxide, and a combination of other metals or metal oxides, such as sodium oxide and iron oxide. For example, perlite may comprise about 70% to 75% SiO₂ by weight, about 12% to 15% Al₂O₃ by weight, about 0.5% to 2% Fe₂O₃ by weight, about 3% to 5% Na₂O by weight, about 3% to 5% K₂O by weight, about 0.4% to 1.5% CaO by weight, and lesser amounts of other metals or metal oxides. Perlite may be distinguished from other glassy minerals by a relatively higher water content (e.g., from about 2% to 5% by weight), a vitreous, pearly luster, and characteristic concentric or arcuate onion skin-like fractures. The Mohs hardness of perlite is typically greater than about 5, such as ranging from about 5.5 to about 7.0.

Expanded perlite refers to perlite that has been heated to cause thermal expansion through vaporization of its internal water. For example, perlite may be heated quickly to a point where the glass begins to soften (between about 750° C. and 1100° C.) and the water recombines and vaporizes. The water vapor can expand as long as the glass is soft enough to stretch with it, resulting in small bubbles in the glass matrix that can break and lead to smaller fragments with sharp edges.

Pumice is a glassy mineral characterized by a mesoporous structure, e.g., having pores or vesicles. The porous nature of pumice gives it a relatively low apparent density, in many cases allowing it to float on the surface of water. Pumice generally comprises from about 60% to about 70% SiO₂ by weight. Obsidian materials include glassy minerals that are rich in silica. Obsidian glasses may be classified into subcategories according to their silica content, with rhyolitic obsidians (containing typically about 73% SiO₂ by weight) being the most common. Rice hulls contain sufficient silica that they can be commercially ashed for their siliceous residue, a product commonly known as rice hull ash. Certain sponges are also concentrated sources of silica, the remnants of which may be found in geologic deposits as acicular spicules.

The mineral particles may be abrasive, e.g., having a generally fragmented shape with sharp or otherwise irregular edges. Further, for example, the mineral particles may function as a mechanical pesticide (e.g., mechanical insecticide). Without intending to be bound by theory, it is believed that the chemical composition, shapes, and/or sizes of the mineral particles may be effective in, or at least contribute to, killing pests according to the methods herein. For example, sharp edges of the particles may scratch the waxy or oily outer cuticle layer (e.g., exoskeleton) of arthropods, which then can result in death by dehydration. Such lacerations also may facilitate the pest's exposure to a organic pesticide adsorbed to surfaces of, or otherwise incorporated into, the mineral particles. Further, for example, the particles may attach to lipid compounds on the outer surface of the pest and absorb water, other fluids, and/or lipids from the pest, leading to desiccation and eventual death.

Additionally or alternatively, the mineral particles may have an electrostatic charge. For example, the electrostatic charge may facilitate adsorption or incorporation of the organic pesticide with the mineral particles. According to some aspects of the present disclosure, the mineral particles, optionally together with an electrostatic charge of the organic pesticide, may impart electrostatic properties to the composition that facilitate application of the composition to a substrate and/or exposure of the composition to the pest. For example, the electrostatic charge may be sufficient to serve as a driving force for transferring the composition to the pest, e.g., to attach to lipid compounds on the outer surface of the pest.

The electrostatic charge of the mineral particles and/or the composition (mineral particles and organic pesticide(s) associated therewith) may be determined, for example, by measuring the zeta potential and/or surface potential.

For example, measuring the zeta potential of the mineral particles, e.g., using a zeta-potential analyzer, may indicate the degree of electrostatic repulsion between particles. Zeta potential is generally measured by introducing particles into a liquid medium and measuring the difference in electric potential (e.g. units mV) between the fluid immediately surrounding the particles (interfacial double layer) and the liquid medium. A higher zeta potential (i.e., higher absolute value of a positive or negative potential) corresponds to greater electrostatic charge. An exemplary zeta-potential analyzer that may be used to determine electrostatic charge is a Zetasizer Nano Z system by Malvern Instruments Ltd.

Additionally or alternatively, the electrostatic charge of the mineral particles and/or composition may be determined by measuring the surface energy, e.g., via inverse gas chromatography. In this technique, a solid (e.g., mineral particles, or mineral particles with organic pesticide(s) associated therewith) is used as the chromatographic column and a gas or vapor is injected into the column. The time required for the gas or vapor to traverse the column (together with characteristics of the gas or vapor) can be used to determine the surface energy, and hence the voltage. An exemplary instrument that may be used to determine electrostatic charge is the Inverse Gas Chromatography-Surface Energy Analyzer (iGC-SEA) produced by Surface Measurement Systems Ltd.

The mineral particles may undergo one or more processing steps, such as milling and/or classification, to provide a desired particle size distribution. For example, the mineral particles may be milled such that the particles have a desired size distribution. In some examples, the mineral particles may have a fine or ultrafine size distribution. Mineral particulates having a smaller (including, e.g., ultrafine) particle size distribution may have relatively sharper edges than mineral particulates having a relatively larger particle size distribution. Smaller particles may also be more easily transferred and attached to the body of the pest.

Particle sizes and other particle size properties referred to in the present disclosure may be measured by any appropriate measurement technique, such as, for example, a Sedigraph 5100 instrument, as supplied by Micromeritics Corporation, or a Microtrac Model X-100, as supplied by Leeds & Norththrup. Using such measuring devices, the size of a given particle is expressed in terms of the diameter of a sphere of equivalent diameter, sometimes referred to as equivalent spherical diameter or (ESD). The median particle size, or the d₅₀ value is the diameter at which 50% by weight of the particles have an ESD less than the d₅₀ value. Similarly, the d₉₀ value is the diameter at which 90% by weight of the particles have an ESD less than the d₉₀ value, and the d₁₀ value is the diameter at which 10% by weight of the particles have an ESD less than the d₁₀ value. Other methods and/or devices for determining particle sizes are contemplated.

According to some aspects of the present disclosure, the mineral particles may have a median particle diameter (d₅₀ value) of 15 μm or less, such as ranging from about 2 μm to about 12 μm, from about 5 μm to about 10 μm, or from about 2 μm to about 5 μm. Additionally or alternatively, the mineral particles may have a d₉₀ value of 45 μm or less, such as ranging from about 5 μm to about 35 μm, from about 10 μm to about 30 μm, or from about 15 μm to about 20 μm. Further, for example, the mineral particles may have a d₁₀ value of 2.5 μm or less, such as ranging from about 0.2 μm to about 2.0 μm, from about 0.5 μm to about 1.5 μm, or from about 0.5 μm to about 1.0 μm.

In some examples herein, the mineral particles may have a d₅₀ value of 10 μm or less, a d₉₀ value of 45 μm or less, and a d₁₀ value of 2.5 μm or less. For example, the mineral particles may have a d₅₀ value of 5 μm or less, a d₉₀ value of 35 μm or less, and a d₁₀ value of 1.5 μm or less. In at least one example, the mineral particles may have a d₅₀ value of 3 μm or less, a d₉₀ value of 11 μm or less, and a d₁₀ value of 1.2 μm or less. According to some aspects of the present disclosure, the mineral particles may have a d₅₀ particle size ranging from 0.5 μm to 12 μm, such as from 1 μm to 10 μm, from 2 μm to 8 μm, from 3 μm to 5 μm, from 4 μm to 6 μm, from 1 μm to 2 μm, from 0.5 μm to 2 μm, or from 0.5 μm to 1 sm. Further for example, the mineral particles may have a d₁₀ value ranging from 0.2 μm to 5 μm, such as from 0.5 μm to 3 μm, from 0.7 μm to 1.5 μm, or from 1 μm to 1.5 μm, and/or the mineral particles may have a d₉₀ value ranging from 10 μm to 40 μm, such as from 25 μm to 35 μm, from 30 μm to 35 μm, from 20 μm to 25 μm, or from 30 μm to 40 μm. The mineral particles may comprise, for example, perlite or diatomaceous earth.

According to some aspects of the present disclosure, the surfaces of the mineral particles may be treated, e.g., chemically modified or partially or fully coated with a material. Such surface treatments may render the particles more hydrophobic or more hydrophilic. For example, the mineral particles may be modified by silanization to render the surfaces more hydrophobic. In an exemplary silanization process, the mineral particles can be placed in a vessel and a small quantity of dimethyldichlorosilane (SiCl₂(CH₃)₂) or hexadimethylsilazane ((CH₃)₃Si—NH—Si(CH₃)₃) added. Reaction at the particle surface may proceed for a suitable amount of time, such as 12 to 24 hours. Other hydrophobic coatings such as polydimethylsiloxane (PDMS) can also be used.

As mentioned above, the mineral particles may have an electrostatic charge. In some examples herein, the surface charge of the mineral particles may be modified, e.g., to increase a positive surface charge of the mineral particles. For example, the mineral particles may be treated with various coating agents such as amine-containing molecules, multivalent metal cations, or amino acids, to increase a positive surface charge.

The composition comprises one or more organic pesticides. Organic pesticides suitable for the present disclosure include biopesticides and organic small molecule pesticides. The organic pesticide(s) may be natural or synthetic, including, for example, synthetic molecules or complexes that are structurally similar and/or functionally similar to a naturally occurring compound or complex.

Without intending to be bound by theory, it is believed that organic pesticides can kill, impair the movement, and/or suppress the growth, mating, and/or reproduction of a pest by various mechanisms. For example, the organic pesticide may disrupt regulation of the development, behavior, and/or physiological state of a pest, e.g., by activating or inhibiting a receptor, and/or may inhibit or promote biological processes in order to impair or kill the pest.

A biopesticide refers to a biological material, e.g., biological molecule or microorganism, that has pesticidal activity. In some cases, for example, the biopesticide may comprise a biological macromolecule, such as a peptide, a protein, a nucleic acid (e.g., an oligonucleotide or a polynucleotide), a lipid, a carbohydrate, any complex thereof, or any derivative thereof. The biopesticide may comprise a biological molecule obtained or derived from a biological organism.

According to some aspects of the present disclosure, the biopesticide may comprise a peptide. In some cases, the biopesticidal peptide may be a neurotoxin. The neurotoxin may be derived (e.g., from the venom) from scorpions, spiders, hornets, ants, or sea anemones. Examples of neurotoxins include, but are not limited to, BeIT insectotoxin-1, polyhedron-BeIT fusion peptide, Androctonus australis insect toxin (AaIT), Txp-I, LqhαIT, and GS-omega/kappa-HXTX-Hv1a. In some cases, the biopesticidal peptide may disrupt regulation of various biological systems of the pest. For example, the biopesticidal peptide may comprise diuretic hormone, juvenile hormone esterase, eclosion hormone, prothoracicotropic hormone, pheromone biosynthesis activating neuropeptide, helicokinin-II, any combination thereof, or any derivative thereof. In some cases, the biopesticide may comprise a degradative enzyme, such as, e.g., chitinase, protease (e.g., stromelysin, gelatinase, cathepsin, etc.), enhancin, AcMNPV viral fibroblast growth factor, keratinase, any combination thereof, or any derivative thereof. Other biopesticidal peptides that may be used include crystalline (Cry) toxins, glycosylase, urease, amylase inhibitors, cysteine protease inhibitors, cystatin inhibitors, soyacystatin N, oryzacystatins, canatoxins, jaburetox-2Ec, lectin, vicilin, any combination thereof, or any derivative thereof.

According to some aspects of the present disclosure, the biopesticide may comprise an oligonucleotide or polynucleotide, which may be natural or artificial. Examples include, but are not limited to, RNA, DNA, RNA-DNA hybrids, and peptide nucleic acids (PNA). For example, the biopesticide may comprise an interference RNA (RNAi) molecule, such as a small interfering RNA (siRNA), a small hairpin RNA (shRNA), a microRNA (miRNA), or any other antisense RNA molecules. The biopesticidal oligonucleotide or polynucleotide may be double-stranded, single-stranded, or a hybrid thereof. In some cases, the biopesticide may comprise a delivery system for RNAi molecules. The delivery system may comprise a cell (e.g., a bacterium or a yeast) or a virus that produces RNAi molecules, for example.

An RNAi molecule may suppress the expression of a target gene in a pest. The target gene may be involved in the development, metabolism, survival, growth, reproduction, or neurotransmission in the pest. In some cases, an RNAi molecule may target a gene involved in transcription, translation, cytoskeleton function and structure, cell-cycle, metabolism (anabolism or catabolism), endocytosis, intracellular and intercellular transport, calcium binding, nucleus import and export, nucleic acid binding, signal peptidase-protein binding, the proteasome, vesicle transport, neuro-transmission, water-balance, ion-balance, splicing, mitosis, meiosis, chromosome organization, stability or integrity, micro RNA function and production, siRNA function and production, posttranslational protein modifications, electron transport, apoptosis, membrane integrity, and/or cell adhesion of the pest.

In some examples, the biopesticide may comprise a microorganism, e.g., a bacterium, fungus, virus or protozoan. Examples of microbial biopesticides include, but are not limited to, Bacillus thuringiensis, Bacillus thuringiensis tenebrionis, Bacillus thuringiensis kurstaki, Bacillus sphaericus, Bacillus subtilis, Agrobacterium radiobacter, Bulkholderia cepacia, Pseudomonas fluorencens, Pseudomonas syringae, Streptomyces griseoviridis, Trichoderma viride, Trichoderma virens, Trichoderma harzianum, Verticillium lecanii, Beauveria bassiana, Colletotrichum gloeosporioides, among other examples of microbial biopesticides.

In some examples, the biopesticide may be a plant growth regulator (e.g., gibberellins, cytokinins, abscisic acid, ethylene, auxins), an insect growth regulator (e.g., azadirachtin), a pest feeding deterrent (e.g., a compound that causes the pest to stop feeding), an organic acid (e.g., peracids), a plant extract, a pheromone, or any combination thereof.

According to some aspects of the present disclosure, the organic pesticide may comprise a small organic molecule, such as an antibiotic insecticide. Examples include, but are not limited to, allosamidin, thuringiensin; macrocyclic lactone insecticides such as spinosad, spinetoram, and other spinosyns including the 21-butenyl spinosyns and their derivatives; avermectin insecticides such as abamectin, doramectin, emamectin, eprinomectin, ivermectin and selamectin; milbemycin insecticides such as lepimectin, milbemectin, milbemycin oxime and moxidectin; botanical insecticides such as anabasine, azadirachtin, d-limonene, nicotine, pyrethrins, cinerins, cinerin I, cinerin II, jasmolin 1, jasmolin II, pyrethrin I, pyrethrin II, quassia, rotenone, ryania and sabadilla; carbamate insecticides such as bendiocarb and carbaryl; benzofuranyl methylcarbamate insecticides such as benfuracarb, carbofuran, carbosulfan, decarbofuran and furathiocarb; dimethylcarbamate insecticides dimitan, dimetilan, hyquincarb and pirimicarb; oxime carbamate insecticides such as alanycarb, aldicarb, aldoxycarb, butocarboxim, butoxycarboxim, methomyl, nitrilacarb, oxamyl, tazimcarb, thiocarboxime, thiodicarb and thiofanox; phenyl methylcarbamate insecticides such as allyxycarb, aminocarb, bufencarb, butacarb, carbanolate, cloethocarb, dicresyl, dioxacarb, EMPC, ethiofencarb, fenethacarb, fenobucarb, isoprocarb, methiocarb, metolcarb, mexacarbate, promacyl, promecarb, propoxur, trimethacarb, XMC and xylylcarb; dinitrophenol insecticides such as dinex, dinoprop, dinosam and DNOC; formamidine insecticides such as amitraz, chlordimeform, formetanate and formparanate; fumigant insecticides such as acrylonitrile, chloropicrin, para-dichlorobenzene, 1,2-dichloropropane, ethyl formate, ethylene dibromide, ethylene dichloride, ethylene oxide, hydrogen cyanide, iodomethane, methyl bromide, methylchloroform, methylene chloride, naphthalene, phosphine, sulfuryl fluoride and tetrachloroethane; chitin synthesis inhibitors such as bistrifluoron, buprofezin, chlorfluazuron, cyromazine, diflubenzuron, flucycloxuron, flufenoxuron, hexaflumuron, lufenuron, novaluron, noviflumuron, penfluoron, teflubenzuron and triflumuron; juvenile hormone mimics such as epofenonane, fenoxycarb, hydroprene, kinoprene, methoprene, pyriproxyfen and triprene; juvenile hormones such as juvenile hormone I, juvenile hormone II, and juvenile hormone III; moulting hormone agonists such as chromafenozide, halofenozide, methoxyfenozide and tebufenozide; moulting hormones such as α-ecdysone and ecdysterone; moulting inhibitors such as diofenolan; precocenes such as precocene I, precocene II, and precocene III; insect growth regulators such as dicyclanil; nereistoxin analogue insecticides such as bensultap, cartap, thiocyclam and thiosultap; nicotinoid insecticides such as flonicamid; nitroguanidine insecticides such as clothianidin, dinotefuran, imidacloprid and thiamethoxam; nitromethylene insecticides such as nitenpyram and nithiazine; pyridylmethylamine insecticides such as acetamiprid, imidacloprid, nitenpyram and thiacloprid; organochlorine insecticides such as dichlorodiphenyltrichloroethane (DDT), bromo-DDT, camphechlor, pp′-DDT, ethyl-DDD, hexachlorocyclohexane (HCH), gamma-HCH, lindane, methoxychlor, pentachlorophenol, tetrachlorodiphenylethane (TDE); cyclodiene insecticides such as aldrin, bromocyclen, chlorbicyclen, chlordane, chlordecone, dieldrin, dilor, endosulfan, endrin, heptachlor, isodrin, isobenzan, isodrin, kelevan and mirex; organophosphate insecticides such as bromfenvinfos, chlorfenvinphos, crotoxyphos, dichlorvos, dicrotophos, dimethylvinphos, fospirate, heptenophos, methocrotophos, mevinphos, monocrotophos, naled, naftalofos, phosphamidon, propaphos, tetraethyl pyrophosphate (TEPP), and tetrachlorvinphos; organothiophosphate insecticides such as dioxabenzofos, fosmethilan and phenthoate; aliphatic organothiophosphate insecticides such as acethion, amiton, cadusafos, chlorethoxyfos, chlormephos, demephion, demephion-O, demephion-S, demeton, demeton-O, demeton-S, demeton-methyl, demeton-O-methyl, demeton-S-methyl, demeton-S-methylsulphon, disulfoton, ethion, ethoprophos, isothioate, malathion, methacrifos, oxydemeton-methyl, oxydeprofos, oxydisulfoton, phorate, sulfotep, terbufos and thiometon; aliphatic amide organothiophosphate insecticides such as amidithion, cyanthoate, dimethoate, ethoate-methyl, formothion, mecarbam, omethoate, prothoate, sophamide and vamidothion; oxime organothiophosphate insecticides such as chlorphoxim, phoxim and phoxim-methyl; heterocyclic organothiophosphate insecticides such as azamethiphos, coumaphos, coumithoate, dioxathion, endothion, menazon, morphothion, phosalone, pyraclofos, pyridaphenthion and quinothion; benzothiopyran organothiophosphate insecticides such as dithicrofos and thicrofos; benzotriazine organothiophosphate insecticides such as azinphos-ethyl and azinphos-methyl; isoindole organothiophosphate insecticides such as dialifos and phosmet; isoxazole organothiophosphate insecticides such as isoxathion and zolaprofos; pyrazolopyrimidine organothiophosphate insecticides such as chlorprazophos and pyrazophos; pyridine organothiophosphate insecticides such as chlorpyrifos and chlorpyrifos-methyl; pyrimidine organothiophosphate insecticides such as butathiofos, diazinon, etrimfos, lirimfos, pirimiphos-ethyl, pirimiphos-methyl, primidophos, pyrimitate and tebupirimfos; quinoxaline organothiophosphate insecticides such as quinalphos and quinalphos-methyl; thiadiazole organothiophosphate insecticides such as athidathion, lythidathion, methidathion and prothidathion; triazole organothiophosphate insecticides such as isazofos and triazophos; phenyl organothiophosphate insecticides such as azothoate, bromophos, bromophos-ethyl, carbophenothion, chlorthiophos, cyanophos, cythioate, dicapthon, dichlofenthion, etaphos, famphur, fenchlorphos, fenitrothion fensulfothion, fenthion, fenthion-ethyl, heterophos, jodfenphos, mesulfenfos, parathion, parathion-methyl, phenkapton, phosnichlor, profenofos, prothiofos, sulprofos, temephos, trichlormetaphos-3 and trifenofos; phosphonate insecticides such as butonate and trichlorfon; phosphonothioate insecticides such as mecarphon; phenyl ethylphosphonothioate insecticides such as fonofos and trichloronat; phenyl phenylphosphonothioate insecticides such as cyanofenphos, EPN, leptophos; phosphoramidate insecticides such as crufomate, fenamiphos, fosthietan, mephosfolan, phosfolan and pirimetaphos; phosphoramidothioate insecticides such as acephate, isocarbophos, isofenphos, methamidophos and propetamphos; phosphorodiamide insecticides such as dimefox, mazidox, mipafox and schradan; oxadiazine insecticides such as indoxacarb; phthalimide insecticides such as dialifos, phosmet and tetramethrin; pyrazole insecticides such as acetoprole, ethiprole, fipronil, pyrafluprole, pyriprole, tebufenpyrad, tolfenpyrad and vaniliprole; pyrethroid ester insecticides such as acrinathrin, allethrin, bioallethrin, barthrin, bifenthrin, bioethanomethrin, cycletluin, cycloprothrin, cyfluthrin, beta-cyfluthrin, cyhalothrin, gamma-cyhalothrin, lambda-cyhalothrin, cypermethrin, alpha-cypermethrin, beta-cypermethrin, theta-cypermethrin, zeta-cypermethrin, cyphenothrin, deltamethrin, dimefluthrin, dimethrin, empenthrin, fenfluthrin, fenpirithrin, fenpropathrin, fenvalerate, esfenvalerate, flucythrinate, fluvalinate, tau-fluvalinate, furethrin, imiprothrin, metofluthrin, permethrin, biopermethrin, transpermethrin, phenothrin, prallethrin, profluthrin, pyresmethrin, resmethrin, bioresmethrin, cismethrin, tefluthrin, terallethrin, tetramethrin, tralomethrin and transfluthrin; pyrethroid ether insecticides such as etofenprox, flufenprox, halfenprox, protrifenbute and silafluofen; pyrimidinamine insecticides such as flufenerim and pyrimidifen; pyrrole insecticides such as chlorfenapyr; tetronic acid insecticides such as spirodiclofen, spiromesifen and spirotetramat; thiourea insecticides such as diafenthiuron; urea insecticides such as flucofuron and sulcofuron; and unclassified insecticides such as AKD-3088, closantel, crotamiton, cyflumetofen, E2Y45, EXD, fenazaflor, fenazaquin, fenoxacrim, fenpyroximate, FKI-1033, flubendiamide, HGW86, hydramethylnon, IKI-2002, isoprothiolane, malonoben, metaflumizone, metoxadiazone, nifluridide, NNI-9850, NNI-0101, pymetrozine, pyridaben, pyridalyl, Qcide, rafoxanide, rynaxypyr, SY-159, triarathene, triazamate, and any combinations thereof.

Commercial examples of biopesticides that may be used in the compositions and methods herein include, but are not limited to, Regalia® and Grandevo® produced by Marrone Bio Innovations, Inc., Bio-Tam® and Taegro@ produced by Isagro, Spear™ formulations produced by Vestaron, Polyversum@ produced by Gowan, and CIRKIL® formulations produced by Terramera, Inc.

Any of the foregoing organic pesticides may be used in combination in the compositions and methods herein. For example, the composition may comprise two or more different peptides, two or more different polynucleotides, two or more different microorganisms, etc. Further, in some examples, the composition may comprise multiple types of organic pesticides, e.g., multiple types of biopesticides, small molecule insecticides, or combinations thereof. For example, the composition may comprise at least 2, 3, 4, 5, 6, 7, 8, 9, or 10 or more different types of organic pesticides. In at least one example, the composition comprises mineral particles and at least two organic pesticides chosen from peptides, oligonucleotides, polynucleotides, lipids, carbohydrates, microorganisms, and antibiotic insecticides. For example, the at least two organic pesticides may comprise at least two biopesticides, such as a peptide and microorganism, a peptide and a polynucleotide (e.g., an interference RNA molecule), or a peptide and an antibiotic insecticide.

According to some aspects of the present disclosure, the composition may comprise mineral particles and a biopesticide comprising a RNAi molecule. For example, the mineral particles may comprise perlite, e.g., expanded perlite, and/or diatomaceous earth.

The composition may comprise various amounts of organic pesticide(s), e.g., depending on the type(s) of organic pesticide, the target pest, and the surface to be treated (e.g., crops, greenhouse plants, etc.).

The compositions herein may be prepared by combining the mineral particles and the organic pesticide(s) using any suitable technique. For example, the mineral particles may be milled or otherwise mixed with one or more organic pesticides in order to incorporate the organic pesticide(s) into the mineral particles. Further, for example, the organic pesticide(s) may be applied or incorporated into mineral particles by dusting, sprinkling, soaking, aerating, misting, fogging, spraying (e.g., through an atomizer or other type of spray nozzle), direct/indirect application of droplets of the organic pesticide(s), application of the dried residue of the formulation, immersion of the mineral particles in a bath, etc.

In some examples, the mineral particles and the organic pesticide may be heated, e.g., to melt or decrease the viscosity of the organic pesticide to facilitate adsorption or coating of the mineral particles with the organic pesticide. Organic pesticides in liquid form may be sprayed onto the mineral particles, or dissolved in a solvent and then sprayed onto the mineral particles, followed by evaporation of the solvent. Further, for example, the mineral particles introduced into a solution that comprises a organic pesticide, e.g., dissolved in a solvent. The solvent then may be evaporated with the application of heat, or under reduced pressure or vacuum. Exemplary solvents include, but are not limited to, polar solvents such as acetone, methanol, ethanol, propanol, isomers of propanol including 1- and 2-, propanol (n- and iso-propanol, respectively), methyl ethyl ketone, diethyl ketone, acetonitrile, ethyl acetoacetate, and lower alkyl alcohols. In some examples, the organic pesticide(s) may be dissolved in a polar aprotic solvent that has ion dissolving power but lacks an acidic hydrogen. Examples of polar aprotic solvents include, but are not limited to, dimethyl sulfoxide (DMSO), dimethylformamide, dioxane, hexamethylphosphorotriamide, and methyl sulfoxide.

The compositions herein may be in the form of a dry powder, a wettable powder (e.g., particles in a dilute solution), or a slurry. In some examples, the slurry may comprise the mineral/organic pesticide composition, water, and optionally a soap or surfactant (including, e.g., fatty acids, emulsifying surfactants), dispersant, wetting agent, buffering agent, acidifying agent, antifoaming agent, thickener, and/or antifreeze. Examples of such agents suitable for the compositions herein may include, but are not limited to, Agicide Activator®, Herbimax®, Maximizer®, and MSO® all available from Loveland company, and Dyne-Amic produced by Helena Chemical Co. According to some aspects, the composition may be applied using an aerosol delivery system as discussed below.

According to some aspects of the present disclosure, the composition may have an electrostatic charge. For example, the mineral particles with organic pesticide(s) associated therewith may have a net positive or net negative surface charge. Without intending to be bound by theory, it is believed that the electrostatic charge may assist in delivery of the composition to a substrate and/or in attaching the composition to the pest for delivery of the organic pesticide(s). For example, the electrostatic charge may provide for more uniform deposition and/or targeted deposition within a chosen area or onto a substrate that is grounded or oppositely charged. Additionally or alternatively, the electrostatic charge of the composition may facilitate delivery to the target pest population. For example, the electrostatic charge may provide a driving force for the composition to attach to the pest (e.g., the outer surface of the pest, such as the arthropod cuticle) during or after application of the composition to the area or substrate. For example, the composition may be applied to an agricultural or horticultural commodity, such as a plant leaf, and may attach to the body of an insect on or proximate to the leaf, assisted by electrostatic forces.

Provided herein are methods for pest control. Pest control may include reducing or eliminating the number of targeted pest in an area, such as an area of or proximate a surface of a substrate. The substrate may at least one of an agricultural or horticultural commodity, a building surface (e.g., a wall surface or ground surface), single or double sided tape, or netting.

According to some aspects of the present disclosure, the composition may be applied to a substrate prior to, or at the same time as, the composition is applied or exposed to the pest. In at least one example, the substrate may include netting, and the system may further include a binder associated with the netting, wherein the binder adheres the composition to the netting. For example, the binder may include a polymer, such as an acrylic polymer. In another example, the substrate may include an adhesive tape, such as a single-sided or double-sided adhesive tape, to which the composition may adhere. Exemplary tapes that could be used as a substrate for the compositions herein include double sided tapes with different tackiness such as 3M 666 (low density polyethylene (LDPE) liner with repositionable medium tack adhesive 1070 on a clear UPVC film carrier), 3M 9415PC (high tack 3M™ 400 acrylic adhesive on one side and low tack 3M™ 1000 series repositionable acrylic adhesive (‘post it’) on the other side of a polyester film carrier) and 3M 9425 (high tack acrylic adhesive 420 on one side and medium tack acrylic adhesive 1050 on the other side polycoated kraft paper liner with a UPVC carrier).

For example, a mineral/organic pesticide composition in powder form may be applied to the exposed tacky surface of tape by pressing the composition to the surface or by blowing the composition onto the tape surface using compressed gas. The loading level of composition on the tape can be calculated by measuring the weight increase of the tape after application of the composition and the tape area. In some examples, the loading level may range from about 5 g/m² to about 100 g/m², such as from about 10 g/m² to about 80 g/m², from about 20 g/m² to about 70 g/m², or from about 35 g/m² to about 55 g/m².

In further examples, the composition may be applied using an aerosol delivery system. For example, the aerosol delivery system can include a container suitable for holding pressurized gas and spraying powder, such as that described in U.S. Pat. Nos. 9,389,771; 6,394,321; or 6,581,807. The aerosol delivery system may also include a propellant, such as for example a mixture of isobutane and propane (e.g. propellant A-46) or a liquefied petroleum gas (e.g. propellant blend A70). In some aspects, the composition may be combined with an unmatured anhydrous alcohol that includes a propellant alcohol such as SD-40 or SDAG-6 capable of evaporating rapidly once sprayed to leave the composition deposited on the surface.

The compositions herein may be applied to agricultural or horticultural commodities. For example, the substrate onto which the composition is applied may include crops and other plants (e.g., medicinal plants, decorative plants, etc.), seeds, grain, vegetables, fruits, herbs, and/or other products derived from a plant. In some examples, the composition may be applied to plant such that the composition adheres to the plants. According to some aspects of the present disclosure, the composition may be mixed with seeds, grain, and/or other products derived from a plant. Non-limiting examples of plants that may be treated with the compositions herein include corn plants, citrus trees, chickpea plants, broccoli plants, lettuce plants, cabbage plants, strawberry plants, cereal plants, oilseed plants, fruit trees, berry plants, vegetables, pasture plants, and forage plants.

The methods herein may comprise applying the composition to a substrate or other targeted area once, or two or more times. The composition may be applied multiple times over a period of time effective to eliminate, reduce, or otherwise control a population of pests. For example, the method may comprise applying the composition over a period of days, weeks, or months. The composition may be applied at a predetermined frequency, such as once a week or once a month. In some examples, the method may result in a reduced pest population, such as a reduction of at least 10%, at least 20%, at least 30%, at least 40%, at least 50%, or at least 60% or more within a given amount of time, such as one week, two weeks, 30 days, 60 days, or 90 days.

Aspects of the present disclosure are further illustrated by reference to the following, non-limiting numbered exemplary embodiments.

1. A method for controlling a pest population, the method comprising: applying a composition to an area, the composition comprising mineral particles and at least one biopesticide associated with the mineral particles; wherein the mineral particles have a size distribution with a ds diameter of 15 μm or less; and wherein the composition attaches to a pest in the area to deliver the at least one biopesticide to the pest.

2. The method according to embodiment 1, wherein the mineral particles comprise at least one of a silicate material or an aluminosilicate material.

3. The method according to embodiment 1 or 2, wherein the mineral particles comprise diatomaceous earth, expanded perlite, or a mixture thereof.

4. The method according to any of embodiments 1-3, wherein the at least one biopesticide comprises a peptide, an oligonucleotide, a polynucleotide, a lipid, a carbohydrate, a microorganism, or a combination thereof.

5. The method according to any of embodiments 1-4, wherein the at least one biopesticide comprises a peptide or an interference RNA molecule.

6. The method according to any of embodiments 1-5, wherein the at least one biopesticide is adsorbed to surfaces of the mineral particles or at least partially incorporated into crevices of the mineral particles.

7. The method according to any of embodiments 1-6, wherein the composition has an electrostatic charge sufficient to serve as a driving force for transferring the composition to the pest.

8. The method according to embodiment 7, wherein the electrostatic charge is positive.

9. The method according to any of embodiments 1-8, wherein the mineral particles have a d₁₀ diameter of 2.5 μm or less and a d₉₀ diameter of 45 μm or less.

10. The method according to any of embodiments 1-9, wherein the mineral particles have a d₅₀ diameter ranging from about 2 μm to about 12 μm, from about 5 μm to about 10 μm, or from about 2 μm to about 5 μm.

11. The method according to any of embodiments 1-10, wherein the pest is an insect or an arachnid.

12. The method according to any of embodiments 1-11, wherein the composition is applied to a substrate chosen from an agricultural commodity, a horticultural commodity, a building surface, a tape, or a netting.

13. The method according to any of embodiments 1-12, wherein the composition is applied to the area at least twice within 30 days.

14. The method according to any of embodiments 1-13, wherein the pest population is reduced by at least 20% within 30 days.

15. A method for controlling a pest population, the method comprising: applying a composition to a substrate, wherein the composition comprises mineral particles and at least one organic pesticide associated with the mineral particles; wherein the mineral particles have a size distribution with a d₅₀ diameter of 15 μm or less; and wherein the composition has an electrostatic charge sufficient to transfer the composition from the substrate to a pest proximate the substrate to deliver the at least one organic pesticide to the pest.

16. The method according to embodiment 15, wherein the electrostatic charge is positive.

17. The method according to claim 15 or 16, wherein the pest is an insect or an arachnid.

18. The method according to any of embodiments 15-17, wherein an outer surface of the pest includes lipid compounds.

19. The method according to any of embodiments 15-18, wherein the at least one organic pesticide comprises a biopesticide chosen from a peptide, an oligonucleotide, a polynucleotide, a lipid, a carbohydrate, a microorganism, or a combination thereof.

20. The method according to any of embodiments 15-19, wherein the at least one organic pesticide comprises a small molecule insecticide.

21. The method according to any of embodiments 15-20, wherein the mineral particles comprise expanded perlite, diatomaceous earth, or a mixture thereof.

22. The method according to any of embodiments 15-21, wherein the mineral particles have a d₅₀ diameter ranging from about 2 μm to about 12 μm, from about 5 μm to about 10 μm, or from about 2 μm to about 5 μm.

23. A composition comprising: mineral particles comprising a silicate, an aluminosilicate, or a combination thereof, the mineral particles having a d₅₀ diameter of 15 μm or less; and at least one biopesticide adsorbed to surfaces of the mineral particles or at least partially incorporated into crevices of the mineral particles.

24. The composition according to embodiment 23, wherein the mineral particles have a d₅₀ diameter ranging from 2 μm to 12 μm, a d₁₀ diameter ranging from 0.2 μm to 2 μm, and a d₉₀ diameter ranging from 5 μm to 35 μm.

25. The composition according to embodiment 23 or 24, wherein the mineral particles comprise diatomaceous earth, expanded perlite, or a combination thereof.

26. The composition according to any of embodiments 23-25, wherein the at least one biopesticide comprises a peptide, an oligonucleotide, a polynucleotide, a lipid, a carbohydrate, a microorganism, or a combination thereof.

27. The composition according to any of embodiments 23-26, wherein the at least one biopesticide comprises a peptide or an interference RNA molecule.

28. The composition according to any of embodiments 23-27, wherein the composition has an electrostatic charge sufficient to serve as a driving force for transferring the composition to a pest.

29. The composition according to embodiment 28, wherein the electrostatic charge is positive.

30. The composition according to any of embodiments 23-29, wherein the composition is in the form of a dry powder or a slurry.

31. Use of the composition according to any of embodiments 23-30 for controlling a pest population.

32. A system for controlling a pest population comprising the composition according to any of embodiments 23-30.

33. The system according to embodiment 32, further comprising a substrate, wherein the composition is deposited on at least a portion of the substrate.

Other aspects and embodiments of the present disclosure will be apparent to those skilled in the art from consideration of the specification and practice of the embodiments disclosed herein.

It is intended that the specification and examples therein be considered as exemplary only, with a true scope and spirit of the present disclosure being indicated by the following claims.

1. A method for controlling a pest population, the method comprising:
applying a composition to an area, the composition comprising mineral particles and at least one biopesticide associated with the mineral particles;
wherein the mineral particles have a size distribution with a do diameter of 15 μm or less; and
wherein the composition attaches to a pest in the area to deliver the at least one biopesticide to the pest.

2. The method of claim 1, wherein the mineral particles comprise at least one of a silicate material or an aluminosilicate material.

3. The method of claim 1, wherein the mineral particles comprise diatomaceous earth, expanded perlite, or a mixture thereof.

4. The method of claim 1, wherein the at least one biopesticide comprises a peptide, an oligonucleotide, a polynucleotide, a lipid, a carbohydrate, a microorganism, or a combination thereof.

5. The method of claim 4, wherein the at least one biopesticide comprises a peptide or an interference RNA molecule.

6. (canceled)

7. The method of claim 1, wherein the composition has an electrostatic charge sufficient to serve as a driving force for transferring the composition to the pest.

8. The method of claim 7, wherein the electrostatic charge is positive.

9. (canceled)

10. The method of claim 1, wherein the mineral particles have a do diameter ranging from about 2 μm to about 12 μm.

11. The method of claim 1, wherein the pest is an insect or an arachnid.

12. The method of claim 1, wherein the composition is applied to a substrate chosen from an agricultural commodity, a horticultural commodity, a building surface, a tape, or a netting.

13. (canceled)

14. The method of claim 1, wherein the pest population is reduced by at least 20% within 30 days.

15. A method for controlling a pest population, the method comprising:
applying a composition to a substrate, wherein the composition comprises mineral particles and at least one organic pesticide associated with the mineral particles;
wherein the mineral particles have a size distribution with a ds diameter of 15 μm or less; and
wherein the composition has an electrostatic charge sufficient to transfer the composition from the substrate to a pest proximate the substrate to deliver the at least one organic pesticide to the pest.

16. (canceled)

17. The method of claim 15, wherein the pest is an insect or an arachnid.

18. The method of claim 15, wherein an outer surface of the pest includes lipid compounds.

19. The method of claim 15, wherein the at least one organic pesticide comprises a biopesticide chosen from a peptide, an oligonucleotide, a polynucleotide, a lipid, a carbohydrate, a microorganism, or a combination thereof.

20. The method of claim 15, wherein the at least one organic pesticide comprises a small molecule insecticide.

21. The method of claim 15, wherein the mineral particles comprise expanded perlite, diatomaceous earth, or a mixture thereof.

22. The method of claim 15, wherein the mineral particles have a do diameter ranging from about 2 μm to about 12 μm.

23. A composition comprising:
mineral particles comprising a silicate, an aluminosilicate, or a combination thereof, the mineral particles having a ds diameter of 15 μm or less; and
at least one biopesticide adsorbed to surfaces of the mineral particles or at least partially incorporated into crevices of the mineral particles.

24. (canceled)

25. The composition of claim 23, wherein the mineral particles comprise diatomaceous earth, expanded perlite, or a combination thereof.

26. The composition of claim 23, wherein the at least one biopesticide comprises a peptide, an oligonucleotide, a polynucleotide, a lipid, a carbohydrate, a microorganism, or a combination thereof.

27. The composition of claim 23, wherein the at least one biopesticide comprises a peptide or an interference RNA molecule.

28. The composition of claim 23, wherein the composition has an electrostatic charge sufficient to serve as a driving force for transferring the composition to a pest.

29. The composition of claim 28, wherein the electrostatic charge is positive.

30. The composition of claim 23, wherein the composition is in the form of a dry powder or a slurry.
